(19) United States
(12) Patent Application Publication
(10) Pub. No.: US 2003/0203337 A1
(43) Pub. Date: Oct. 30, 2003

(54) Unexpanded perlite ore polishing composition and methods

(76) Inventors: John S. Roulston, Lompoc, CA (US); Dean Klein, Solvang, CA (US)

Correspondence Address: Daniel J. Meaney, Jr., Post Office Box 22307, Santa Barbara, CA, 93121, US

(21) Appl. No.: 10/133,694

(22) Filed: Apr. 25, 2002

(51) Int. Cl. A61C 3/06; A61C 3/02; B24C 1/00

(52) U.S. Cl. 433/142; 433/88; 451/38; 451/75

(57) ABSTRACT

An unexpanded perlite ore polishing composition is shown. The composition comprises base material having grains of unexpanded perlite ore of a selected distribution of particle sizes which undergo fracturing of the grains as a function of an abrasive force applied to the base material. The selected distribution of particle sizes includes a significant volume of grains of unexpanded perlite ore having a particle size of less than about 245 μm. The base material is responsive to an abrasive force being applied thereto during polishing resulting in continued fracturing of the grains of unexpanded perlite ore to yield a final polishing composition having a sufficiently low level of abrasiveness under said abrasive force making it suitable for use in polishing. Methods for preparing and using the unexpanded perlite ore polishing composition are also shown.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO A “MICROFICHE APPENDIX” (SEE 37 CFR 1.96)

Not Applicable

### BACKGROUND OF THE INVENTION

1. Field of the Invention

The present invention relates to a unexpanded perlite ore polishing composition and method for polishing selected materials wherein an unexpanded perlite ore composition having grains of a selected distribution of particle sizes resulting in continued fracturing of the grains subject to an abrasive force applied to the composition during polishing. This results in an increase in the number of grains of unexpanded perlite ore having a smaller particle size than the selected distribution of particle sizes for efficient polishing and more particularly relates to a unexpanded perlite ore polishing composition and method for selectively abrading and polishing polymers, including acrylic polymers, dentures and other parts, components and articles fabricated from materials suitable for polishing with unexpanded perlite ore including optical glass, lenses and cathode ray tubes (CRT) surfaces subject to an abrasive force.

2. Description of the Prior Art

It is known in the art to use granular compositions for abrasion and polishing of the surfaces of an article.

Certain applications utilize pumice as an abrasive material or as an abrasive material additive to a polishing composition. Pumice is a rock froth formed by the extreme puffing of liquid lava by expanding gases liberated from solution in the lava prior to and during solidification. Pumice and pumicite are porous, glassy forms of lava, rich in silica. Both plumice, the massive form, and pumicite, the powder or dust form, have been widely used as a mild abrasive for polishing operations.

FIGS. 1 and 2 labeled “Prior Art” are scanning electron micrographs of pumice grains at magnifications of 100× and 300×, respectively. As depicted in the micrographs of FIGS. 1 and 2, the grains or particles of pumice have a plurality of large pores, or more specifically vesicles, that are an essential part to the definition of rock type. The large pores are separated by a plurality of substantially parallel planes with sharp edges or strata defining the structure thereof. The pumice, when used as an abrasive in a polishing material, typically generates scratches which is generally undesirable. The scratches are formed in the surface of an article by the aforementioned sharp edges of the pumice grains. Scratches generally require additional polishing using a fine polishing composition to remove the same and to polish the surface of the article to the desired finish.

A polish composition and method of use which utilizes suitable mild abrasives, such as pumice, are disclosed in U.S. Pat. No. 6,235,824.

It is also known in the art to use abrasive material in combination with individual grains of pumice in coated abrasive articles comprised of a backing having a layer of grains adherently bonded thereto by a binding material, an example of which is disclosed in U.S. Pat. No. 5,840,090.

It is also known in the art to have a granular composition which utilizes pumice as a part thereof, an example of which is disclosed in U.S. Pat. No. 5,891,473.

It also known in the art that toothpaste can be formulated to include a lightweight, low density solid filler such as expanded perlite as disclosed in U.S. Pat. No. 6,139,820.

It is also known in the art to utilize low density expanded perlite as an abrasive in toothpaste as disclosed in U.S. Pat. No. 5,597,553. Specifically, U.S. Pat. No. 5,597,553 discloses a specific use of an expanded perlite in toothpaste which disintegrates when subjected to small mechanical stress, e.g., under the conditions of tooth brushing, into smaller, sharp-edged particles and that the same are well suited as a cleaning body in the toothpaste. U.S. Pat. No. 5,597,553 further discloses that the relatively course particles of expanded perlite have a size of the order of about 1 μm to 150 μm, the major portion being of about 20 μm. The expanded perlite particles are disclosed as performing a very short-lasting, but intensive cleaning action and are immediately comminuted into still finer particles which then perform a desired, mild polishing action down to a fine polishing. In U.S. Pat. No. 5,597,553, the specification recites that only the exploded (expanded) perlite is used in the toothpaste disclosed therein.

Toothpastes utilizing an expanded perlite are also disclosed in U.S. Pat. Nos. 5,597,553 and 5,124,143.

It is also known in the art to utilize exploded (expanded) perlite in a water-free prophylectic paste containing expanded perlite as disclosed in U.S. Pat. No. 6,139,820.

It is also known in the art that a cleaning composition containing a type II endoglycosidase includes an expanded perlite abrasive as a part thereof as disclosed in U.S. Pat. No. 5,395,541.

It is also known in the art to use a blend of polishing and cleaning agents in a prophylaxis procedure for stain removal and polishing of teeth. Such a blend of polishing and cleaning agents are generally known as prophy paste and may include fluoride ions. Certain of the known prophy paste use expanded perlite and pumice as grit material in the prophy paste. Examples of prophy paste using expanded perlite and pumice are the 3M brand prophy pastes known as 3M™ CLINPRO™ prophy paste and NUPRO® brand prophy paste sold by DENTSPLY. Other known prophy paste products are sold by WhiteHill Manufacturing, Inc. under the trademark Professional Prophy Products.

It is also known to incorporate “soft abrasive” polish into dental floss and dental tape, and such products are sold by WhiteHill Manufacturing, Inc. under the trademark Professional Prophy Products.

An oral prophalaxis paste which includes a preselected grade and amount of abrasive material such as pumice, clay or diatimoceous earth is disclosed in U.S. Pat. No. 6,280,707.

It is also known in the art to utilize pumice as an abrasive material for polishing a CRT glass panel wherein the polishing thereof is conducted in the presence of the abrasive material including the pumice in a state of slurry. In polishing CRT glass panels, the polishing pressures are in a range of about 0.2 kg/cm² (200 kg/cm²) to 2.0 kg/cm² (2000 kg/cm²), more preferably in the range of about 0.4 kg/cm² (400 kg/cm²) to about 1.2 kg/cm² (1200 kg/cm²). Generally, when the abrasive or polishing force is less than about 0.2 kg/cm² (200 kg/cm²), the abrasive or polishing force is usually insufficient and the efficiently of the polishing is reduced. Further, it is known to use multiple grades of pumice to effect the polishing process. Typically, a coarse grade pumice is first used in the polishing process to polish the surface of a CRT which is then followed by polishing using a medium grade pumice.

It is also known to use only a single grade of pumice, typically a finer grade, for polishing a CRT surface and to then use a final polishing operation that employs a cerium oxide to obtain the desired polished surface.

Polishes are used to maintain a glossy finish or sheen on surfaces as well as to prolong the useful lives of these surfaces. Appearance enhancement provided by polishes generally results from materials that smooth and clean surfaces through abrasive action, or leave a glossy coating, or both. A description of polishes and uses thereof are set forth at pages 444 through 453 in the Kirk-Othmer Encyclopedia of Chemical Technology, John Wiley & Sons, 1996, 4^{th} Edition, Vol. 19) (the “Chemical Technology, Vol. 19 Reference”). The Chemical Technology, Vol. 19 Reference is incorporated herein by reference.

Many materials have been used as abrasives, usually in one of three forms in polishing operations: grit (loose, granular, or powdered particles); bonded materials (particles are bonded into wheels, segments, or stick shapes); and coated materials (particles are bonded to paper, plastic, cloth, or metal). Grit is often useful for polishing, buffing, lapping, pressure blasting, barrel finishing, jet cutting, and high-pressure jet cutting. Natural abrasives of commercial significance include diamond, corundum, emery, garnet, silica, sandstone, tripoli, pumice, and pumicite, and to a lesser extent, powdered feldspar and staurolite. A description of abrasives and uses thereof are set forth at pages 17 through 37 of the Kirk-Othmer Encyclopedia of Chemical Technology, John Wiley & Sons, 1991, 4th Edition, Vol. 1 (the “Chemical Technology, Vol. 1 Reference”). The Chemical Technology, Vol. 1 Reference is incorporated by reference.

Other known Natural Glasses and Macerals are disclosed and described in Appendix A, Natural Glasses and Macerals, page 540 through 542, in Mineralogy, W. H. Freeman and Company, 2nd Edition (the “Mineralogy Reference”). The Mineralogy Reference is incorporated by reference.

Materials including Thermoplastic materials and thermoset materials generally recognized as “engineering materials”, including acrylic polymers, are disclosed and described at pages 371 through 511 of The Handbook of Industrial Materials, Elsevier Advanced Technology, 2nd Edition (the “Industrial Materials Reference”). The Industrial Materials Reference is incorporated by reference herein.

Glasses comprise a wide variety of vitreous amorphous polymers consisting of repeating siloxane (i.e., —(Si—O)—) units in the polymer chain. Some glasses are naturally occurring, such as perlite. Others, such as soda-lime glasses, are produced synthetically. Soda-lime glass is made by melting batches of raw materials containing the oxides of silicon (i.e., SiO₂), aluminum (i.e., Al₂O₃), calcium (i.e., CaO), sodium (i.e., Na₂O), and sometimes potassium (i.e., K₂O), or lithium (i.e., Li₂O) together in a furnace, and then allowing the melt to cool so as to produce the amorphous product. Glasses may be made in a wide variety of shapes, including sheets or plates, cast shapes, or fibers. Often, glass is not sufficiently smooth as first produced, for the intended end use, and requires further polishing.

Among the glasses requiring polishing for final use include cathode ray tubes and television tubes, eyeglasses, photographic optical components, and laser optical components. These glasses are prepared in a wide array of chemical compositions, and thus have various hardnesses and physical properties. Being a natural glass itself, the unexpanded perlite ore polishing composition is useful for polishing glasses, provided the glass is equal to or less than the hardness of the unexpanded perlite ore polishing composition.

It is also known in the art to etch or polishing a surface of an article using a method and apparatus for blowing an airstream containing use submicron particles thereacross. One example of a surface process method by blowing submicron particles is disclosed in U.S. Pat. No. 5,928,719.

Principles of grinding and polishing of materials, such as plastics and polymers, including the use of grinding, hand polishing and automated polishing systems are described in Pages 1 through 10 of the STANDARD GUIDE FOR PREPARATION OF PLASTICS AND POLYMERIC SPECIMENS FOR MICROSTRUCTURAL EXAMINATION, Designation: E 2015-99, American Society for Testing and Materials (the “ASTM Standard Guide Reference”). The ATSM Standard Guide Reference in Section 11 captioned “Polishing” sets forth information relating to rough polishing and fine or final polishing. ATSM Standard Guide Reference includes methods for measuring flatness of a polished surface, typical applied pressures to obtain the desired polishing and effective wheel speeds for automated polishing. The disclosures set forth in the ATSM Standard Guide Reference can be used in practicing this invention.

The rate at which the final polishing of a surface can be obtained using the unexpanded perlite ore composition of the present invention can be by microscopical analysis by reflected light.

For example, if the selected distribution of selected sizes of the grains of unexpanded perlite ore composition have a (d₉₀) having a larger particle size, e.g. greater than 245 μm, then the rate at which the unexpanded perlite ore composition comminutes or fractures will be higher which is desirable for a higher level of coarse polishing. On the other hand, if the selected distribution of selected sizes of the grains of unexpanded perlite ore composition have a (d₉₀) having a smaller particle size, e.g. about 100 μm, then the rate at which the unexpanded perlite ore composition comminutes or fractures will lower which is desirable for a fine polish level.

It is envisioned that measurements of rates of effective coarse polishing and fine polishing can be determined by microscopical analysis of a polished surface using reflected light in a manner similar to the method described in Pages 1 through 4 of the STANDARD PRACTICE GUIDE FOR PREPARING COAL SAMPLES FOR MICROSCOPICAL ANALYSIS BY REFLECTED LIGHT, Designation: D2797-85(Reapproved 1999), American Society for Testing and Materials (the “ASTM Microscopical Analysis Reference”). The ATSM Microscopical Analysis Reference in Section 9 captioned “Preparation of Briquet Surface” sets forth information relating to grinding and polishing of a briquet on a lap to obtain a surface suitable for microscopic examination. The same method can be used to determine the effectiveness of both coarse polishing and fine polishing of a desired surface.

The disclosure of all of the above references and Patents and other references referred into this specification are hereby incorporated by reference as if set forth verbatim herein.

### BRIEF SUMMARY OF THE INVENTION

The present invention discloses a new, novel and unique unexpanded perlite ore polishing composition which, through continued fracturing of grains of unexpanded perlite ore having a selected distribution of particle sizes during polishing under an abrasive force, develops a sufficiently low level of abrasiveness making it suitable for use in polishing. The unexpanded perlite ore polishing composition yields a final polishing composition which is capable of achieving a high gloss finish on polymers, including acrylic polymers and dentures under an abrasive force and glass compositions.

The unexpanded perlite ore polishing composition includes a base unexpanded perlite ore material having grains of an unexpanded perlite ore of a selected distribution of particle size which undergo fracturing of the grains as a function of the polishing force applied to the base unexpanded perlite ore material. The selected distribution of particle size of the grains of unexpanded perlite ore have particle sizes of less than about 245 μm. The base unexpanded perlite ore material is responsive to an abrasive force, such as a manually applied physical force or a pressurized gas stream being applied to the base unexpanded perlite ore material during polishing. During the application of an appropriate abrasive force, the grains of unexpanded perlite ore exhibit continued fracturing to yield a final polishing composition having particle sizes of less than about 100 μm. The final polishing composition has a sufficiently low level of abrasiveness making it suitable for use in polishing.

In its broadest aspect, the invention resides in an unexpanded perlite ore polishing composition having a single base material. The single base material comprises grains of unexpanded perlite ore having a selected distribution of particle sizes that range in particle size from about 5 μm to about 352 μm and the selected distribution at about 50 μm by volume of grains of unexpanded perlite ore have a particle size in the range of about 20 μm to about 120 μm.

The base unexpanded perlite ore material is responsive to a force being applied to the base material during polishing resulting in continued fracturing of the grains of unexpanded perlite ore. This yields a final polishing composition with grains of unexpanded perlite ore having a distribution of particle sizes with a greater number of grains of unexpanded perlite ore having a smaller particle size than the number of grains of unexpanded perlite ore having a smaller particle size than the selected distribution of the base material prior to application of the abrasive force.

None of the known prior art, anticipates, discloses, teaches or suggest a unexpanded perlite ore polishing composition having as base material or base composition having grains of an unexpanded perlite ore material. Nor does the known prior art, anticipates, discloses, teaches or suggest a base material or base composition having grains of an unexpanded perlite ore of a selected particle size has an abrasive force applied to the unexpanded perlite ore material that yields a final polishing composition with or having a sufficiently low level of abrasiveness for making it suitable for use in polishing.

This invention is clearly new, novel and unobvious to persons skilled-in-the-art for all the reasons set forth herein.

Therefore, one advantage of the unexpanded perlite ore polishing composition of the present invention is that the base unexpanded perlite ore material having grains of an unexpanded perlite ore having a selected distribution of particle size undergoes continued fracturing of the grains as a function of the abrasive force, e.g., a polishing force, applied to the unexpanded perlite ore material yielding a final polishing composition having a sufficiently low level of abrasiveness making it suitable for use in polishing.

Another advantage of the present invention is that the final polishing composition, which is still in the form of an unexpanded perlite ore, has a distribution of particle sizes having a greater number of smaller grains of unexpanded perlite ore than the number of smaller grains of unexpanded perlite ore having in the selected distribution of the base material prior to application of an abrasion force.

Another advantage of the present invention is that the base unexpanded perlite ore polishing composition has a (d₉₀) particle size of grains of unexpanded perlite ore in the range of about 80 μm to about 245 μm.

Another advantage of the present invention is that the final polishing composition has a distribution of particle size in the range of about 20 μm to about 100 μm with a preferred particle size in the range of about 20 μm to about 50 μm.

Another advantage of the present invention is that the base material includes grains of unexpanded perlite ore having a selected distribution of particle sizes which range in particle size from about 10 μm to about 245 μm. The selected distribution has at least 50% by volume of grains of unexpanded perlite ore having a particle size of about 20 μm to about 120 μm.

Another advantage of the present invention is that the unexpanded perlite ore polishing composition can be used as an unexpanded perlite ore composition for a polishing polymers and acrylic polymers.

Another advantage of the present invention is that the unexpanded perlite ore polishing composition can comprise a base composition comprising a first base unexpanded perlite ore material having grains of unexpanded perlite ore of a first selected distribution of particle size and a second base unexpanded perlite ore material having grains an unexpanded perlite ore of a second selected distribution of particle size, both of which are responsive to a abrasive force to yield a final polishing composition with a distribution of particle size of less than 52 μm and wherein the final polishing composition has a sufficiently low level of abrasiveness making it suitable for use in polishing.

Another advantage of the present invention is that the unexpanded perlite ore polishing composition base material and/or base composition can include a carrier selected from the group consisting of liquids, gases and mixtures thereof.

Another advantage of the present invention is that a method for polishing a surface of an article comprising applying a quantity of unexpanded perlite ore polishing composition comprising a base unexpanded perlite ore material having grains of an unexpanded perlite ore of a selected distribution of particle size and applying an abrasive force to the unexpanded perlite ore base material and fracturing the grains of unexpanded perlite ore to yield a final polishing composition having a sufficiently low level of abrasiveness making it suitable for polishing the surface of an article.

Another advantage of the present invention is that a method for polishing a surface of an article comprising applying a quantity of unexpanded perlite ore polishing composition comprising a base composition having a first base unexpanded perlite ore material and a second base material, each having grains of an unexpanded perlite ore of a selected distribution of particle size and applying an abrasive force to the unexpanded perlite ore base material resulting in controlled fracturing of the grains of unexpanded perlite ore to yield a final polishing composition having a sufficiently low level of abrasiveness making it suitable for polishing the surface of an article under an abrasive force.

Another advantage of the present invention is that the unexpanded perlite ore polishing composition can use in a device for directing a unexpanded perlite ore polishing composition under an abrasive force, e.g., a gas stream under pressure, against a surface of a work piece and polishing the same. An auxiliary polishing force by being applied to the surface by a separate member, e.g., a rotating driven member.

Another advantage of the present invention is that a method of preparing an unexpanded perlite ore polishing composition is shown.

Another advantage of the present invention is that the method of preparing the unexpanded perlite ore polishing composition base material and/or base composition does not require us of the expansive phase as is required for “expanded perlite” products. This is a significant advantage in that the expansion process is a relatively expensive process.

Another advantage of the present invention is that the unexpanded perlite ore polishing composition base material and/or base composition has a density significantly higher than the density of “expanded perlite”, and as such, the unexpanded perlite ore is less likely to dust.

Another advantage of the present invention is that several methods of using the unexpanded perlite ore polishing composition are shown.

Another advantage of the present invention is that the unexpanded perlite ore polishing composition has utility for use in a dental prophalaxis paste.

Another advantage of the present invention is that the unexpanded perlite ore polishing composition has utility for use in a strip material for polishing teeth. The strip material may comprise a strip member comprising a material configured for use as dental floss or for use as dental tape.

### BRIEF DESCRIPTION OF THE DRAWING

The present invention will become more fully understood from the following detailed description of a preferred, but non-limiting, embodiment thereof described in connection with the accompanying drawings wherein:

FIG. 1 is a scanning electron micrograph of grains of pumice magnified 100×;

FIG. 2 is a scanning electron micrograph of grains of pumice magnified 300×;

FIG. 3 is a scanning electron micrograph of grains of unexpanded perlite ore magnified 100×;

FIG. 4 is a scanning electron micrograph of grains of unexpanded perlite ore magnified 300×;

FIG. 5 is a pictorial representation of a typical grain of unexpanded perlite ore having a particle size as shown in FIG. 4 being subjected to an abrasive force;

FIG. 6 is a pictorial representation of the grain of unexpanded perlite ore shown in FIG. 5 fracturing under an abrasive force into smaller grains of unexpanded perlite ore;

FIG. 7 is a pictorial representation of a unexpanded perlite ore polishing composition using the teachings of this invention positioned relative to a surface of a work piece to be polished at the commencement of a polishing process;

FIG. 8 is a pictorial representation of a unexpanded perlite ore polishing composition illustrating the continued fracturing of the grains of larger particle sizes of unexpanded perlite ore having a larger particle size which results in a final polishing composition of grains of unexpanded perlite ore having a smaller particle size;

FIG. 9 is a pictorial representation of a unexpanded perlite ore polishing composition showing the final polishing composition of the unexpanded perlite ore after continued fracturing in response to an abrasive force for providing a polished surface;

FIG. 10 is a pictorial representation of a microblasting nozzle for use with a source of unexpanded perlite ore polishing composition of the present invention and a source of gas pressure as an abrasive force for polishing articles; and

FIG. 11 is a pictorial representation of a nozzle assembly having a nozzle for forming a wide distribution pattern for directing a continuous flow of unexpanded perlite ore polishing composition onto a surface of a optical glass being polished by a rotatable moveable driven polishing member.

### DETAILED DESCRIPTION OF THE INVENTION

### Background

The unexpanded perlite ore polishing composition is made from a natural glass, of which unexpanded perlite ore is the predominating form of natural glass. The term “natural glass” is used here in the conventional sense and refers to natural glasses, commonly referred to as volcanic glasses, which are formed by the rapid cooling of siliceous magma or lava. Most natural glasses are chemically equivalent to rhyolite. Natural glasses which are chemically equivalent to trachyte, dacite, andesite, latite, and basalt are known but are less common. The term “obsidian” is generally applied to dark, most often black, massive natural glasses that are rich in silica (i.e., SiO₂). Obsidian glasses may be classified into subcategories according to their silica content, with rhyolitic obsidians (containing typically about 73% SiO₂ by weight) as the most common.

Unexpanded perlite is a hydrated natural glass containing typically about 72-75% SiO₂, 12-14% Al₂O₃, 0.5-2% Fe₂O₃, 3-5% Na₂O, 4-5% K₂O, 0.4-1.5% CaO (by weight), and small concentrations of other metallic elements. Perlite is distinguished from other natural glasses by a higher content (2 to 10% by weight) of chemically bonded water, the presence of a vitreous, pearly luster, and commonly, but not always, a characteristic concentric or arcuate onion skin-like (i.e., perlitic) fractures. This kind of perlite is sometimes referred to as unexploded perlite, unexpanded perlite, raw perlite or perlite ore.

Since unexpanded perlite is a rhyolitic vitreous rock of volcanic origin, the composition according to elemental analysis will vary due to different origin. For example, for some unexpanded perlite, the SiO₂ may range from 72.1% to 74.2% and the Al₂O₃ may range from 12.3% to 13.5%.

This invention is not limited to any specific perlite composition according to an elemental analysis of unexpanded perlite. It is envisioned that all compositions of unexpanded perlite, sometimes referred to herein as unexpanded perlite ore, can be used in practicing this invention.

It is important to distinguish that the teachings of the present invention resides in the use of unexpanded perlite ore having high density which is on the order of about 65 lbs. per cubic foot to about 70 lbs. per cubic foot. This is distinguished from expanded perlite which has a low density on the order of about 5 lbs. per cubic foot to about 20 lbs. per cubic foot. Expanded perlite is derived from unexpanded perlite ore, or perlite ore, known as a mineral, and is fabricated by heating the unexpanded perlite ore to temperature in the order of 900° C. to 1000° C.

As a result of the immediate heat applied to the perlite ore, the water of hydration within the unexpanded perlite is transformed into a gas phase beginning at about 800° C., and the melted particles expand to a multiple of the initial volume.

The examples discussed herein provide specific examples of a base material or base composition wherein the grains of unexpanded perlite ore have a selected distribution of particle sizes wherein the (d₉₀) is in the range of about 60 μm to about 245 μm.

Fracture characteristics of abrasive materials are important to polishing performance, as well as the resulting grain shapes and microstructural features. This is referred to as perlitic mode of fracture. The perlitic mode of fracture is exceptionally well suited for use in an expanded perlite ore polishing composition for polishing a surface, such as for example an acrylic polymer surface used in fabrication dentifrice. The polishing function is dependent on a final polishing composition having grains of fractured, unexpanded perlite ore in small particle sizes formed by an abrasive force being applied to the unexpanded perlite ore polishing composition.

Thus, this invention resides in use of unexpanded perlite ore and the term “unexpanded perlite ore” is used herein to distinguish the same from expanded perlite. As discussed above, the term “expanded perlite” is used in the art to identify material derived from unexpanded perlite ore, or perlite ore, by heating the unexpanded perlite ore as described above.

In essence, unexpanded perlite ore has significant structural and physical characteristics relative to those of expanded perlite which is the composition generally used as described in the prior art.

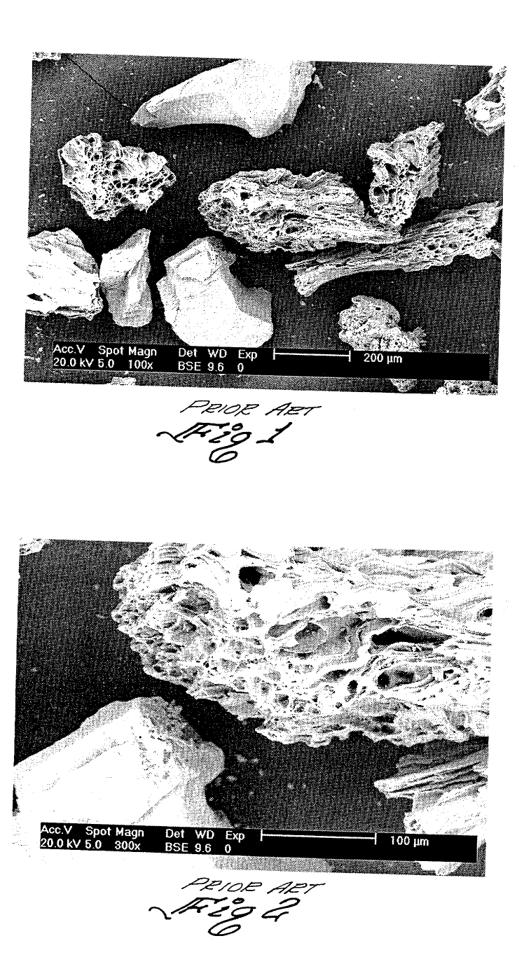

As noted above, FIGS. 1 and 2 are prior art micrographs images that disclose the grain structure of pumice which, during polishing, results in the scratching of the surface being polished. Pumice has a high granular compressive strength (>22N/mm² or 220 kg/cm²).

Typically, pumice is used for coarse polishing of a surface when it is desired to rapidly remove a large quantity of material. An example of such an application is for the initial abrasion polishing performed on a glass CRT tube surface.

Typically, a fine polish is then used on the CRT tube surface after use of the coarse pumice abrasive to remove the scratches and to obtain the desired finish polish on a surface. Use of an unexpanded perlite ore polishing composition of the present invention eliminates the creation of scratches and eliminate the necessity for a first coarse abrasive process step.

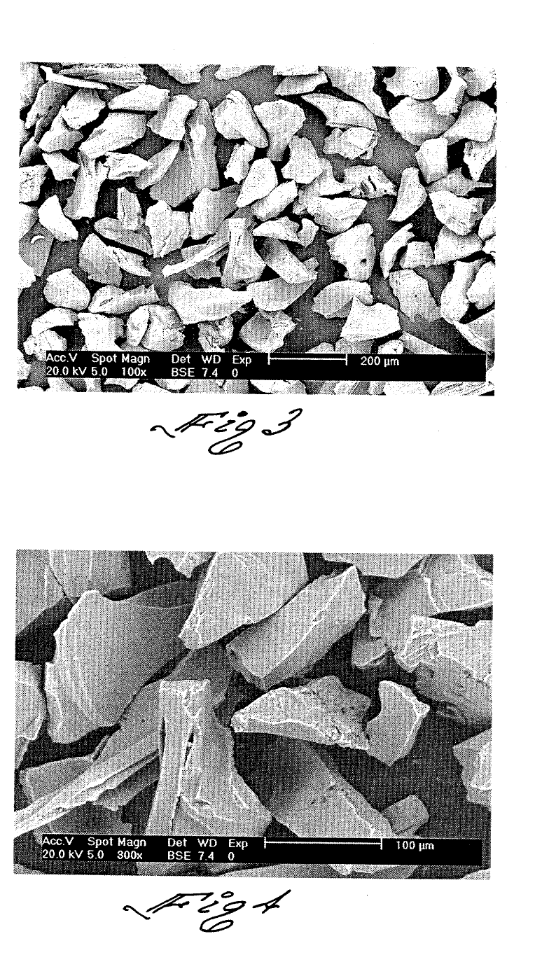

FIGS. 3 and 4 comprise scanning electron micrograph images that disclose the grain structure of unexpanded perlite ore has a smoother exterior surface, as compared to pumice. The structure of the grains of unexpanded perlite ore lend themselves to continued fracturing. That is, the application of an abrasive force, e.g., a polishing force, e.g., a pressurized gas stream, onto a grain of unexpanded perlite ore will cause that grain to fracture into a grain of smaller particle size which is highly desirable. Of course, grains of larger particle size exhibit a higher degree of fracture or of fracturing.

As a result, the interaction between the exterior surface of the grain of unexpanded perlite ore having a relatively smooth exterior surface reacts or co-acts with the surface being polished through friction developed by an abrasive force to yield a fine polishing composition.

FIG. 5 depicts the mechanical process of fracturing of a grain of unexpanded perlite ore shown as 20 having a larger particle size, e.g. 125 μm. The application of an abrasive force to the grain of unexpanded perlite ore 20 is illustrated by arrows 22.

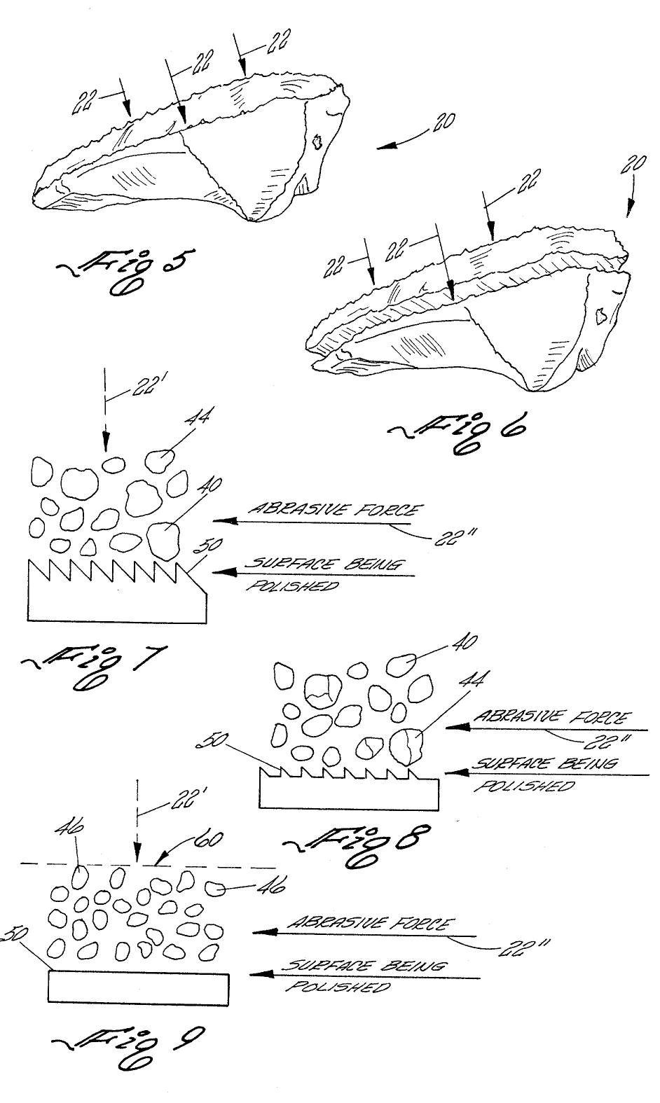

FIG. 6 depicts that the application of the abrasive forces 22 cause continued fracturing or comminution of the grains of unexpanded perlite ore, initially having a larger particle size, into smaller grains of unexpanded perlite ore depicted by fracture sections depicted by 30 and 32. Thereafter, fracture sections of grains depicted by 30 and 32 then respond to the abrasive forces 22 to further fractionize or break into smaller grains of unexpanded perlite ore.

FIGS. 7, 8 and 9 illustrate that the continued application of the abrasive forces 22 continue to result in the fracturing or comminution of the grains of unexpanded perlite ore, having a larger particle size of which the grains depicted in 40 is typical. Subsequently, they yield the fine polishing composition comprising grains of unexpanded perlite ore, of which grains depicted as 44 are typical, which continue to exhibit continued fracturing in response to the abrasive forces 22 resulting in or yielding grains of unexpanded perlite ore 46 which are suitable for polishing a surface 50 of an article.

In FIG. 7, the abrasive force 20 may be applied in a direction depicted by dashed arrow 22′ or as a polishing force shown by arrow 22″. In FIG. 7, the surface 50 is depicted pictorially as having a large sawtooth surface.

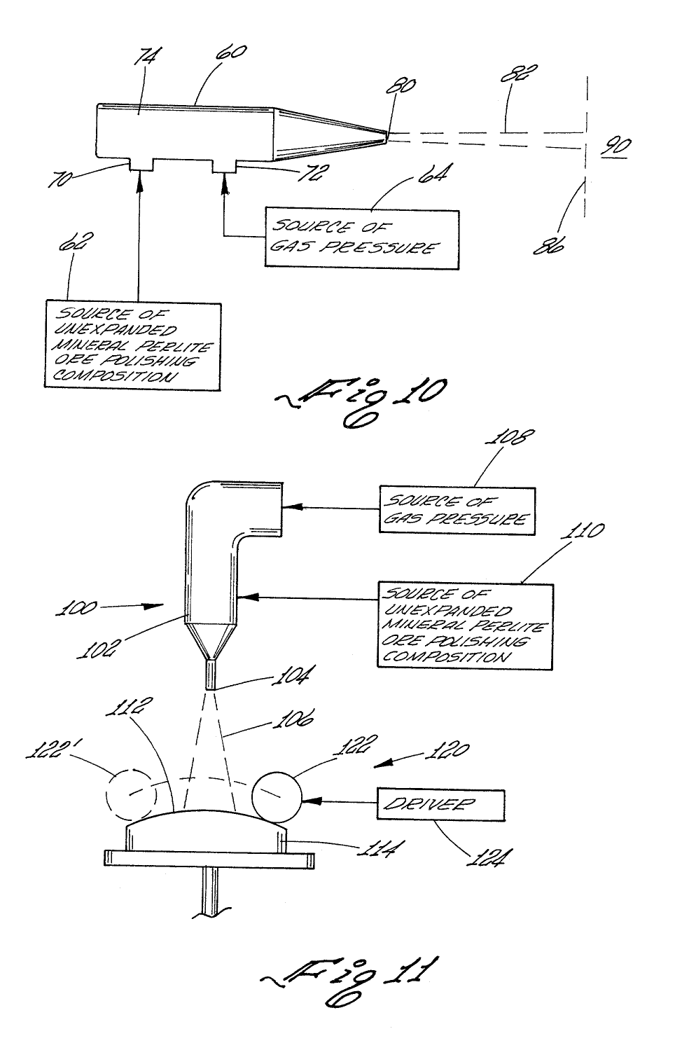

In FIG. 8, surface 50 is depicted as having a reduced sawtooth surface showing that the polishing action is effective. FIG. 9 depicts surface 50 as being polished. The final polishing composition shown in FIG. 9 has a larger number of small grains 46.

The unexpanded perlite composition may be incorporated in or used as a polishing element in a dental prophalaxis paste, or in dental floss or dental tape. For example, the paste element in a dental prophalaxis paste or the strip member in dental floss or dental tape is depicted by dashed line 60 in FIG. 9.

In FIG. 10, the pictorial representation of a microblasting nozzle 60 is used with a source of unexpanded perlite ore polishing composition of the present invention, generally shown as 62, and a source of gas pressure, generally shown as arrow 64.

The nozzle 62 has a first input 70 and a second input 72. First input 70 is operatively coupled to a source of unexpanded perlite ore polishing composition 62 to enable the nozzle 60 to draw grains of unexpanded perlite ore from the source 60 into the chamber 74. The source of gas pressure 64 is to applied to the second input 72 and the gas pressure within chamber 74 develops a differential pressure between the pressure of the gas and atmosphere to draw the grains of unexpanded perlite ore into the chamber 74.

In chamber 74, the grains of unexpanded perlite ore composition are mixed with the gas and are directed out of the nozzle 60, under the pressure of the gas stream, through the nozzle orifice 80. A narrow, pressurized particle stream depicted by dash line 82 is emitted from or directed through the orifice 80. The size, width and pattern of the pressurized particle stream 82 is determined by the nozzle orifice size and shape, the particle sizes of the grains of unexpanded perlite ore and the pressure of the gas stream which functioned as the abrasive force.

The pressurized particle stream 82 comprises both the unexpanded perlite ore polishing composition and a gas stream which functions as an abrasive force, both of which are directed onto a surface 86 of a work piece 90 to polish the surface 86.

In this application, it is desirable that the hardness of the grains of unexpanded perlite ore forming the unexpanded perlite ore polishing compositions generally have a hardness of approximately equal to the hardness of glass beads. The use of glass beads and the characteristics of thereof including hardness are known to persons skilled in the art.

The use of the microblasting device described above with respect to FIG. 10 has applications for treating the surfaces of materials used primarily in the aerospace and medical fields. In the aerospace field, the unexpanded perlite ore polishing composition may be used for polishing of aluminum aircraft parts. In the medical field, the unexpanded perlite ore polishing composition may be used for treating stainless steel medical devices, i.e., reamers and drivers.

In typical applications, air is used as the gas and air pressures may vary from 40 psi to about 150 psi. The actual pressure is determined by the particle size of the unexpanded perlite ore and the width of the pressurized particle stream.

Smaller areas to be treated by using the microblasting assembly described in FIG. 10 will be treated with air pressures of about 60 psi using a nozzle having a diameter of about 0.25 inches which is of sufficient size to pass a pressurized particle stream using the unexpanded perlite ore polishing compositions disclosed herein.

It is envisioned that larger surfaces would use higher air pressure than 60 psi and nozzle orifices having a diameter greater than 0.25 inches.

A composition of unexpanded perlite ore using the teachings of the present invention has utility as a microblasting agent in that such a composition, particularly a fine unexpanded perlite ore composition, may be used in lieu of or in combination with aluminum oxide. Aluminum oxide is presently used as a microblasting agent for etching of aluminum and stainless steel. Also, it is envisioned that the unexpanded perlite ore composition could be used in lieu of or in combination with glass beads used as a microblasting agent.

FIG. 11 is a pictorial representation of a nozzle having a wide distribution pattern for applying a continuous flow of unexpanded perlite ore polishing composition onto a surface of a optical glass being polished by a moveable polishing member.

In FIG. 11, the pictorial representation of a nozzle assembly is shown generally by arrow 100. A source of gas pressure 108 and a source of a unexpanded perlite ore polishing composition 110, using the teachings of this invention, are applied as and used as inputs to the nozzle assembly 100.

The nozzle assembly 100 includes a nozzle 102 having an orifice 104 having a wide continuous pressure distribution pattern identified as by dash lines 106. The nozzle 102 applies a continuous flow of pressurized stream of unexpanded perlite ore polishing composition onto a surface 112 of a optical glass work piece 114. The surface 112 is simultaneously being polished by rotating, movable polishing member shown generally as 120.

The nozzle 104 generates the spray pattern, shown by dash lines 106, comprising a stream of unexpanded perlite ore polishing composition, under appropriate pressure, which is directed on to the surface 112 to be polished. In this example, the surface 112 is located on a CRT glass tube 114.

The polishing member 120 is a rotating polishing member 122 driven by a drive member 124 across the surface 112. The drive rotating member 122 contacts and applies a polishing force on the unexpanded perlite ore polishing composition which is directed on to the surface 112 by the spray pattern 106. The unexpanded perlite ore polishing composition reacts with the surface 112 as a result of abrasive forces generated by both the actions of the: (i) continuous spray pattern 106, under the appropriate gas pressure and volume as a polishing force; and (ii) the polishing force applied by the driven polishing member 122 resulting in the surface 112 being polished to a highly polished surface.

Many polymers have surfaces that require polishing to obtain a high gloss. The term “polymers” as used herein includes thermoplastic and thermoset materials. Thermoplastic materials are those which soften under the action of heat and harden again to their original characteristics on cooling, that is, the heating-cooling cycle is fully reversible. By conventional definition, thermoplastics are straight and branched linear chain organic polymers with a molecular bond. Examples of well-known thermoplastics include products of acrylonitrile butadiene styrene (ABS), styrene acrylonitrile (SAN), acrylate styrene acrylonitrile (ASA), and methacrylate butadiene styrene (MBS). Also included are polymers of formaldehyde, known as acetals; polymers of methyl methacrylate, known as acrylic plastics; polymers of monomeric styrene, known as polystyrenes; polymers of fluorinated monomers, known as fluorocarbons; polymers of amide chains, known as nylons; polymers of paraffins and olefins, known as polyethylenes, polypropylenes, and polyolefins; polymers composed of repeating bisphenol and carbonate groups, known as polycarbonates; polymers of terephthalates, known as polyesters; polymers of bisphenol and dicarboxylic acids, known as polyarylates; and polymers of vinyl chlorides, known as polyvinyl chlorides (PVC). High performance thermoplastics have extraordinary properties, for example, polyphenylene sulfide (PPS), which has exceptionally high strength and rigidity; polyether ketone (PEK), polyether ether ketone (PEEK), polyamide imide (PAI), which have very high strength and rigidity, as well as exceptional heat resistance; and polyetherimide (PEI), which has inherent flame resistance. Unusual thermoplastics include ionomers, i.e., copolymers of ethylene and methacrylic acid that have ionic rather than covalent crosslinking which results in behavior resembling that of thermoset plastics in their operating range; polyvinylcarbazole, which has unique electrical properties; and polymers of isobutylene, known as polyisobutylenes, which are viscous at room temperature.

Thermoset plastics are synthetic resins that are permanently changed upon thermal curing, that is, they solidify into an infusible state so that they do not soften and become plastic again upon subsequent heating. However, certain thermoset plastics may exhibit thermoplastic behavior over a limited portion of their useful application ranges, and are similarly useful as matrix components of the present invention. Some types of thermoset plastics, especially certain polyesters and epoxides, are capable of cold curing at room temperature. Thermoset plastics include alkyds, phenolics, epoxides, aminos (including urea-formaldehyde and melamine-formaldehyde), polyimides, and some silicon plastics.

The properties and applications of thermoplastics and thermoset plastics are disclosed and described in greater detail in the Industrial Materials Reference. Of all the polymers aforementioned, acrylic polymers are most useful for dentures, an application for which the unexpanded perlite ore polishing composition is particularly well suited.

### Unexpanded Perlite Ore Polishing Composition

The unexpanded perlite ore polishing composition utilizes, in one embodiment, a base material having grains of unexpanded perlite ore. The particle size distribution of the unexpanded perlite ore used in the base unexpanded perlite ore is selected to be within a prescribed or selected distribution range for the unexpanded perlite ore polishing composition to obtain the desired speed of polishing and surface gloss. The particle size distribution of the unexpanded perlite ore polishing composition is best determined in accordance with the phenomenon of scattered light from a laser beam projected through a stream of particles. The amount and direction of light scattered by the particles is measured by an optical detector array and then analyzed by a microcomputer which calculates the size distribution of the particles in the sample stream. Data reported may be collected on a Leeds and Northrup Microtrac X100 laser particle size analyzer (Leeds and Northrup, North Wales, Pa.). This instrument can determine particle size distribution over a particle size range from about 0.12 microns to about 704 microns.

In this description, the distribution of particle size in unexpanded perlite ore is designated on the bottom particle size (d₁₀), the median particle size (d₅₀) and top particle size (d₉₀) being defined as that size for which 10 percent, 50 percent, or 90 percent of the volume is smaller than the indicated size, respectively. The examples discusses herein provide specific examples of a base material or base composition wherein the grains of unexpanded perlite ore have a selected distributed of particle sizes wherein the (d₉₀) is in the range of about 60 μm to about 162 μm.

It is envisioned that the following selected distribution of particle size can be used in the unexpanded perlite ore polishing composition of the present invention.

| | | Range of | Range of |
|---|---|---|---|
| | Range of | Particle Size | Particle |
| | Particle | at (d₉₀) | Size at (d₅₀) |
| | Size (μm) | Volume (μm) | Volume(μm)P |
| Base Material | 1.0 to 1000 | 80 to 244 | 20 to 100 |
| (Prior to | | | |
| screening) | | | |
| Base Material* | 12 to 244 | Approximately | Approximately |
| (After | | 94 | 55 |
| Screening) | | | |
| First Base** | 12 to 352 | 140 to 160 | 60 to 80 |
| Unexpanded | | | |
| perlite ore | | | |
| Material | | | |
| Second Base*** | 1.2 to 296 | 60 to 90 | 20 to 30 |
| Unexpanded | | | |
| perlite ore | | | |
| Material | | | |
| Base | 1.3 to 352 | 110 to 130 | 30 to 50 |
| Composition | | | |
| (Blend of first | | | |
| base unexpanded | | | |
| perlite ore | | | |
| material and | | | |
| second base | | | |
| unexpanded | | | |
| perlite ore | | | |
| material at a | | | |
| 50:50 Ratio) | | | |

*Harborlite Perlite Grade PA-1000 (See Example 1) using a 200-mesh sieve, with the material passing through the sieve retained
**Harborlite Perlite Grade PA-1000 (See Example 1) using a 100-mesh sieve, with the material passing through the sieve retained
***Harborlite Perlite Grade PA-4000 (See Example 2) using a 100-mesh sieve, with the material passing through the sieve retained

A method of making unexpanded perlite ore polishing composition includes the step of first preparing, from a crushed and milled unexpanded perlite ore, a base material which provides grains of unexpanded perlite ore having the desired distribution of particle sizes.

The so formed unexpanded perlite ore composition is applied to a surface to be polished, e.g. dentures, and an appropriate polishing force is applied top the unexpanded perlite ore polishing composition, e.g. for polishing acrylic polymer dentures, is applied in an appropriate motion, e.g., for polishing an acrylic polymer, a polishing motion in the form of a buffing wheel against the acrylic polymer surface being polished.

### Final Polishing of Surface

Formal quantitation of the shininess of a surface, such as, glossy polymer surfaces, is rare. Typically, a visual judgment of appearance is usually sufficient for many applications.

However, one useful method of quantitatively determining the degree of polishing is by measurement of sheen. For example, the sheen of a polymer may be measured by determining the 85° sheen, sometimes referred to as specular gloss, of the polymer. A calibrated Glossgard® II 85° glossmeter (Pacific Scientific, Silver Springs, Md.) may be placed over a polished surface. A reading obtained directly from the instrument. If the reading is greater than the 85° Sheen, the reading indicates that the surface is glossier than an 85% sheen.

### EXAMPLES

The following are examples of unexpanded perlite ore polishing compositions using the teachings of the present invention.

### Example 1

The following example utilizes Harborlite Perlite Grade PA-1000 and the specifications thereof is as follows:

| PRODUCT: | HARBORLITE PERLITE | | |
|---|---|---|---|
| GRADE: | PA-1000 | | |
| COMPOSITION: | Perlite, amorphous alumina silicate. | | |
| DENSITY: | 65.0-70.0 lbs. per cubic foot (bulk density). | | |
| BULK SPECIFIC | 1.43 g/ml | | |
| GRAVITY: | | | |
| pH: | 7.6 | | |
| SURFACE | <0.3 | | |
| MOISTURE: | | | |
| DRY SCREEN | | −100 | |
| ANALYSIS | 100 | 200 | −200 |
| TYPICAL RANGE: | 0.0-8.0 | 20.0-47.0 | 50.0-75.0 |
| (% Retained) | | | |

| | |
|---|---|
| CHEMICAL | 72.0% SiO2; 13.0% Al2O3; 4.5% Na2O; .7% CaO; .7% Fe2O3; |
| ANALYSIS: | 5.0% K2O; 1% TiO2; < .1% MgO; <.1% SO3; .1% MnO2; 1.1 H2O; |
| | 2.8 LOI. |

Harborlite® PA 1000 (Harborlite Corporation, Santa Barbara, Calif.) was screened through a 100-mesh sieve, with the material passing through the sieve retained. A particle size distribution of d₁₀=31.4 μm, d₅₀=70 μm, and d₉₀=128 μm was obtained for this product. This product is particularly well suited to coarse polishing of highly irregular surfaces. An example of such surfaces are the surfaces of molded or cast part using “engineering materials” set forth in the Industrial Materials Reference. This composition can also be used in a prophy paste.

### Example 2

The following example utilizes Harborlite Perlite Grade PA-4000 and the specifications thereof is as follows:

| PRODUCT: | HARBORLITE PERLITE | | | |
|---|---|---|---|---|
| GRADE: | PA 4000 | | | |
| COMPOSITION: | Perlite, amorphous alumina silicate. | | | |
| DENSITY: | 65.0-70.0 lbs. per cubic foot (bulk density). | | | |
| BULK SPECIFIC | 1.43 g/ml | | | |
| GRAVITY: | | | | |
| pH: | 7.6 | | | |
| SURFACE | <0.3 | | | |
| MOISTURE: | | | | |
| DRY SCREEN | PLUS | −200 | −325 MINUS | MINUS |
| ANALYSIS | 200 | 325 | 400 | 400 |
| TYPICAL RANGE: | 10.0 | 8.4 | 4.4 | 77.2 |
| (% Retained) | | | | |

| | |
|---|---|
| CHEMICAL | 72.0% SiO2; 13.0% Al2O3; 4.5% Na2O; .7% CaO; .7% Fe2O3; 5.0% |
| ANALYSIS: | K2O;.1% TiO2; <.1% MgO; <.1% SO3; .1% MnO2; 1.1 H2O; 2.8LOI. |

Harborlite® PA 4000 (Harborlite Corporation, Santa Barbara, Calif.) was screened through a 100-mesh sieve, with the material passing through the sieve retained. A particle size distribution of d₁₀=5.7 μm, d₅₀=24 μm, and d₉₀=71 μm was obtained for this product. This product is particularly well suited to fine polishing of surfaces. An example of such surfaces are the surfaces of acrylic polymer used for dentures or parts fabricates using a polymer set forth in the Industrial Materials Reference.

### Example 3

Harborlite® PA 4000 (Harborlite Corporation, Santa Barbara, Calif.) (See Example 2 for Specifications) was screened through a 200-mesh sieve, with the material passing through the sieve retained. A particle size distribution of d₁₀=5.5 μm, d₅₀=23 μm, and d₉₀=60 μm. This product is particularly well suited to fine polishing of surfaces, where greater top size control of the polish is desired to avoid scratches. An example of such surfaces are the surfaces of parts formed of “engineering materials” set forth in the Industrial Materials Reference.

### Example 4

Harborlite® PA 1000 (Harborlite Corporation, Santa Barbara, Calif.) (See Example 1 for Specification) was screened over 140-mesh sieve, and captured on a 200-mesh sieve as the product, with the material passing through the sieves discarded. A particle size distribution of d₁₀=78 μm, d₅₀=110 μm, and d₉₀=162 μm was obtained for this product. This product is particularly well suited to coarse polishing of highly irregular surfaces, but where greater top size control is desired to avoid scratches. An example of such surfaces are the surfaces of parts formed of “engineering materials” as set forth in the Industrial Materials Reference and surfaces of a CRT tube. This composition can also be used in a prophy paste.

### Example 5

Harborlite® PA 1000 (Harborlite Corporation, Santa Barbara, Calif.) (See Example 1 for Specification) was screened over 140-mesh sieve, with the material passing through the sieves discarded.

A particle size distribution of d₁₀=110 μm, d₅₀=152 μm, and d₉₀=218 μm was obtained for this product. This product is particularly well suited for very fast coarse polishing of manufactured products, e.g. parts formed of “engineering materials” as set forth in the Industrial Materials Reference.

Also, this composition has utility for rapid polishing of surfaces of a CRT tube.

### Example 6

Harborlite® 1000 (Harborlite Corporation, Santa Barbara, Calif.) (See Example 1 for Specification) was screened through a 100-mesh sieve, and Harborlite® 4000 (See Example 2 for Specification) was also screened through a 100-mesh sieve, with the material passing through the sieves retained. The two portions retained were then combined in a 50:50 proportion by weight to obtain the desired particle size distribution of (d₁₀)=9 μm, (d₅₀)=45 μm, and (d₉₀)=122 μm. A tablet of High Impact Hi-I® dental acrylic (Fricke Dental International, Inc., Villa Park, Ill.) having an initial 850 Sheen of 4.7 was polished with the unexpanded perlite ore abrasive polishing product in a water slurry on a buffing wheel. Polishing forces were in the range of about 0.2 kg/cm² (200 kg/cm²) to about 0.5 kg/cm² (500 kg/cm²). The tablet achieved a high gloss, having a 850 Sheen of 61.2.

The Following are examples of methods for preparing specific unexpanded perlite ore polishing compositions.

### Example 7

### Methods for Preparing a Unexpanded Perlite Ore Polishing Composition for Surfaces Requiring a High Polish

Fine unexpanded perlite ore polishing composition obtained from crushing and milling of unexpanded perlite ore, such as Harborlite® PA-4000 or Harborlite® PA-1000 (Harborlite Corporation, Santa Barbara, Calif.), are suitable as feed material to prepare the unexpanded perlite ore polishing composition (See Examples 1 and 2 for Specifications). One useful method of preparing the unexpanded perlite ore polishing composition is by screening the feed material through a 100-mesh (150 μm) screen to remove oversize particles that would otherwise scratch the surfaces being polished. Other methods to remove oversize grains of particles and to develop a selected distribution of particle sizes of unexpanded perlite ore suitable for practicing this invention include air classifying, mechanical classifying, air tabling, cycloning, hydrocycloning, riffling, rocking, elutriating, centrifuging or sedimenting. The use of the term “selected distribution of particle size”, as used herein, envisions using any of the above methods for developing a base material, a first base unexpanded perlite ore material, a second base unexpanded perlite ore material or a blend of the above having grains of a selected distribution of unexpanded perlite ore size.

Examples of materials requiring a highly polished surface which can be highly polished using the teachings of the present invention include optical glass and lenses glass, provided the glass is equal to or less than the hardness of the unexpanded perlite ore polishing composition.

### Example 8

### Methods of Using the Unexpanded Perlite Ore Polishing Composition for Acrylic Polymers

The unexpanded perlite ore polishing composition for polymers described above may be used in a manner analogous to the currently available abrasive polishing products. It is particular useful when used as a grit polish for dentures, in which it may be applied in a water slurry on a buffing wheel under an appropriate abrasive force or polishing force.

The preferred embodiment for practicing this invention is for the polishing of dentures using the unexpanded perlite ore polishing composition of Example 2 above. However, it is envisioned that the unexpanded perlite ore polishing composition in substantially the same embodiment or a variations thereof including, without limitation the examples described herein, may have utility for polishing surface of “engineering materials” specified in the Industrial Materials Reference and surfaces of other known materials as described in all of the references set forth above. It will be appreciated that various alterations and modifications may be made to the unexpanded perlite ore polishing composition to enhance the functional characteristics thereof. All such variations and modifications should be considered to fall within the scope of the invention as broadly hereinbefore described and as claimed hereafter.

The final polishing composition of the unexpanded perlite ore polishing composition of the present invention has a distribution of particle sizes having a greater number of grains of unexpanded perlite ore having a smaller size than the number of grains of unexpanded perlite ore having a smaller particle sizes in the selected distribution in the base material or base composition as discussed above. It is desirable that the grains of unexpanded perlite ore have a distribution of particle size in the range of about 20 μcm to about 100 μm. The preferred range would be about 20 μm to about 50 μm. It is preferred that substantially all of the grains of unexpanded perlite ore in the final polishing composition be below 50 μm.

The teachings of the present invention has utility for use as a dentifrice such as a dental prophalaxis paste. The dental prophalaxis paste comprises a composition having a base material having grains of unexpanded perlite ore of a selected distribution of particle sizes which undergo fracturing of the grains as a function of an abrasive force applied to the base material. The selected distribution of particle sizes include a significant volume of grains of unexpanded perlite ore having a particle size of less than about 245 μm. The base material is responsive to an abrasive force being applied thereto during polishing resulting in continued fracturing of the grains of unexpanded perlite ore to yield a final polishing composition having a sufficiently low level of abrasiveness under said abrasive force making it suitable for use in polishing. The composition would include a paste component.

Known paste components include a preselected amount and grade of pumice, clay, glycerin and, alternatively, may include an amount of triclosan for providing antimicrobial properties. The pumice and/or clay in the paste component may be replaced by the unexpanded perlite ore composition of the present invention. Also, the pumice and/or clay, or both, could be retained in the paste as a component and the unexpanded perlite ore composition may be added as an additional component to the paste.

The teachings of the present invention could be used as a strip material for polishing teeth. The strip material for polishing teeth comprises a strip member configured for polishing teeth and a base material incorporated into the strip materials wherein the base material includes grains of unexpanded perlite ore of a selected distribution of particle sizes which undergo fracturing of the grains as a function of an abrasive force applied to the base material. The selected distribution of particle sizes includes a significant volume of grains of unexpanded perlite ore having a particle size of less than about 245 μm. The base material is responsive to an abrasive force being applied thereto during polishing resulting in continued fracturing of the grains of unexpanded perlite ore to yield a final polishing composition having a sufficiently low level of abrasiveness under the abrasive force making it suitable for use in polishing. The strip material may comprise a strip member comprising a material configured for use as dental floss or for use as dental tape.

Abrasive forces for practicing this invention may be in the range of about 0.1 kg/cm² (100 kg/cm²) to about 0.7 kg/cm² (700 kg/cm²). The preferred range is in the order of about 0.2 kg/cm² (200 kg/cm²) to about 0.5 kg/cm² (500 kg/cm²).

Another use of the compositions of the present invention is that the compositions, such as those set forth in Examples 4 and 5 above, can be used to replace use of pumice for polishing in steps where a coarse grade pumice is first used to polish the surface of a CRT which is then followed by polishing using a medium grade pumice in that a single composition can be used in lieu of separate steps of polishing using different grades of pumice.

It is envisioned that the use of the unexpanded perlite ore composition as a microblasting agent would preferably utilize a composition generally limited to a maximum particle size of about 100 μm or less. Such unexpanded perlite ore compositions can be used in lieu of the known microblasting agents which typically have a median particle size of about 25 μm and 50 μm, respectively, for microetching, as opposed to polishing, of aluminum metal and stainless steel for manufacture of components such as, for example, jet turbine engines. In addition, the composition of the present invention can be used in lieu of or in combination with alumina which is used to etch enamel in highly specialized microblasting applications.

In an overview, it is envisioned that the compositions of the present invention could have a distribution of particle sizes including a significant volume of grains of unexpanded perlite ore having a particle size of greater than about 222 μm if the polishing process can tolerate use of the same, such as for example, scratching of the surface due to coarse particle size or that the polishing process can be continued, with concern for time of polishing, to yield a final polishing composition having a sufficiently low level of abrasiveness under said abrasive force making it suitable for use in polishing.

As a general principal, a polishing composition having unexpanded perlite ore having particle sizes greater than the ranges disclosed and taught herein will take longer to decompose. Conversely a polishing composition having unexpanded perlite ore having particle sizes smaller than the ranges disclosed and taught herein will take less time to decompose.

The examples disclosed herein are intended to cover such applications discussed therein, and it is envisioned that such other uses of a unexpanded perlite ore composition will become apparent to those skilled-in-the-art and such uses are envisioned to be within the teaching of the present invention.

All such uses, variations, modifications and the like are anticipated to be within the scope of this invention.

What is claimed is:

1. An unexpanded perlite ore polishing composition comprising
a base material having grains of unexpanded perlite ore of a selected distribution of particle sizes which undergo fracturing of the grains as a function of an abrasive force applied to the base material, said selected distribution of particle sizes including a significant volume of grains of unexpanded perlite ore having a particle size of less than about 245 μm, said base material being responsive to an abrasive force being applied thereto during polishing resulting in continued fracturing of the grains of unexpanded perlite ore to yield a final polishing composition having a sufficiently low level of abrasiveness under said abrasive force making it suitable for use in polishing.

2. The unexpanded perlite ore polishing composition of claim 1 wherein said final polishing composition, subsequent to the application of an abrasive force, contains a particle size distribution with a greater number of smaller grains sizes than the selected distribution of particle sizes of smaller grains sizes in said base material.

3. The unexpanded perlite ore polishing composition of claim 1 wherein said base perlite material has a (d₉₀) particle size in the range of about 50 μm to about 245 μm.

4. The unexpanded perlite ore polishing composition of claim 1 wherein said base perlite material has a (d₉₀) particle size of less than 245 μm and said final polishing composition has a (d₉₀) particle size in the range of about 20 μm to about 100 μm.

5. The unexpanded perlite ore polishing composition of claim 1 wherein said base perlite material has a (d₉₀) particle size in the range of about 50 μm to about 245 μm and the final polishing composition has a distribution of particle sizes in the range of about 20 μm to about 50 μm.

6. A polishing composition comprising:
a base material including grains of unexpanded perlite ore having a selected distribution of particle sizes which range from about 5 μm to about 245 μm, said selected distribution at 50% by volume of grains of unexpanded perlite having a particle size of about 10 μm to about 120 μm, said base material being responsive to a abrasive force being applied to the base material during polishing resulting in continued fracturing of the grains of unexpanded perlite to yield a final polishing composition with a distribution of particle sizes having a greater number of grains of perlite having a smaller particle size than the number of grains of perlite having a smaller particle size in said selected distribution and wherein said final polishing composition has a sufficiently low level of abrasiveness making suitable for use in polishing.

7. The polishing composition of claim 6 wherein selected distribution of particle sizes has a (d₉₀) particle size of less than about 245 μm.

8. The polishing composition of claim 7 wherein said selected distribution has a (d₅₀) particle sizes of less than about 100 μm.

9. The unexpanded perlite polishing composition of claim 1 wherein the final polishing composition has a distribution of particle sizes of less than about 20 μm configured for polishing dentures.

10. A unexpanded perlite ore composition comprising a base material having grains of a unexpanded perlite ore of a selected particle size which undergo fracturing of the grains as a function of an abrasive force applied to the base material, said selected distribution of particle size has a (d₉₀) a particle size of about 60 μm to about 245 μm, said base material being responsive to an abrasive force being applied thereto during polishing resulting in continued fracturing of the grains of perlite ore to yield a final polishing composition with a distribution of particle sizes with a greater number of grains of perlite ore having a smaller particle size than the number of grains of perlite ore having a smaller particles size in said selected distribution and wherein said final polishing composition has a sufficiently low level of abrasiveness making it suitable for use in polishing.

11. The unexpanded perlite ore composition of claim 10 wherein the final polishing composition has a distribution of particle sizes of less than about 50 μm.

12. The unexpanded perlite ore composition of claim 11 wherein the final polishing composition has a distribution of particle sizes of less than about 50 μm configured for polishing polymers.

13. The unexpanded perlite ore composition of claim 11 wherein the final polishing composition has a distribution of particle sizes of less than about 50 μm configured for polishing acrylic polymers.

14. The unexpanded perlite ore composition of claim 11 wherein the final polishing composition has a distribution of particle sizes of less than about 20 μm configured for polishing dentures.

15. The unexpanded perlite ore composition of claim 11 wherein the final polishing composition has a distribution of particle sizes of less than about 20 μm configured for use with prophy paste.

16. The unexpanded perlite composition of claim 11 wherein the distribution of particle sizes distribution is selected such that (d₉₀) is less than about 60 μm.

17. A unexpanded perlite ore polishing composition comprising
a base composition comprising
a first base unexpanded perlite ore material having grains of unexpanded perlite ore of a first selected distribution of particle sizes which result in continued fracturing of the grains of unexpanded perlite ore as a function of an abrasive force applied to the base composition, said selected distribution of particle sizes (d₉₀) having particle size of less than about 128 μm;
a second base unexpanded perlite ore material having grains of unexpanded perlite ore of a second selected distribution of particle sizes which result in continued fracturing of the grains as a function of an abrasive force applied to the base composition, said grains of unexpanded perlite ore having a selected distribution of particle sizes wherein substantially all of the grains have particle size (d₉₀) of less than about 82 μm;
said base composition being responsive to an abrasive force being applied to the first base unexpanded perlite ore material and second base unexpanded perlite ore material during polishing by resulting in continued fracturing of the grains of unexpanded perlite ore to yield a final polishing composition having a distribution of particle sizes of less than about 50 μm and wherein said final polishing composition has a sufficiently low level of abrasiveness making it suitable for use in polishing.

18. The perlite polishing composition of claim 17 wherein said base composition further includes
a carrier selected from the group of consisting of liquid, paste and mixtures thereof.

19. A method for polishing a surface of an article comprising
applying to a surface of an article to be polished a quantity of a unexpanded perlite ore polishing composition comprising a base unexpanded perlite ore material having grains of unexpanded perlite ore of a selected distribution of particle sizes which result in continued fracturing of the grains as a function of an abrasive force applied to the base material, said grains of unexpanded perlite ore have a selected distribution of particle sizes wherein substantially all of the grains have particle sizes of less than about 245 μm;
applying an abrasive force to said base material resulting in the continued fracturing of the grains of unexpanded perlite ore to yield a final polishing composition having a distribution of particle sizes of less than about 50 μm and a sufficiently low level of abrasiveness making it suitable for use in polishing the surface of an article.

20. The method of claim 19 wherein the step of applying includes a base material having a selected distribution of particle sizes having a (d₉₀) in the range of about 82 μm to about 162 μm.

21. The method of claim 19 wherein the step of applying includes a base material having a selected distribution of particle sizes having a (d₉₀) of less than 245 μm and the final polishing composition has a distribution of particle sizes in the range of about 20 μm to about 100 μm.

22. The method of claim 19 wherein the step of applying includes a base material having a selected distribution of particle sizes having a (d₉₀) in the range of about 60 μm and the final polishing composition has a distribution of particle sizes in the range of about 20 μm to about 5 μm.

23. A method for polishing a surface of an article comprising
applying to a surface of an article to be polished a quantity of a unexpanded perlite ore polishing composition comprising a base composition having a first base perlite ore material having grains of unexpanded perlite ore of a first selected distribution of particle size which results in continued fracturing of the grains as a function of an abrasive force applied thereto, said selected particle size having a (d₉₀) of less than about 128 μm and a second base unexpanded perlite ore material having grains of unexpanded perlite ore having a second selected distribution of particle sizes which results in continued fracturing of the grains as a function of an abrasive force applied to the base composition, said second selected distribution of particle sizes having a (d₉₀) of less than about 82 μm; and
applying an abrasive force to said base composition fracturing the grains of unexpanded perlite ore to yield a final polishing composition having grains of unexpanded perlite ore having particle sizes of less than about 50 μm and a sufficiently low level of abrasiveness making it suitable for use in polishing the surface of an article.

24. A method of preparing an unexpanded perlite ore polishing composition comprising the steps of:
crushing and milling a perlite ore to from a source of unexpanded perlite ore having grains of a wide range of particle sizes; and
sorting the unexpanded perlite ore grains to form a base material of grains having a selected distribution of particle sizes.

25. The method of claim 24 wherein the step of sorting includes the use of at least one of a 100-mesh screen, a 140-mesh screen and a 200-mesh screen.

26. The method of claim 24 wherein the step of sorting produces a base material having grains of unexpanded perlite ore having a selected distribution size wherein the particle sizes of the grains are less than 245 μm.

27. The method of claim 24 wherein the step of sorting produces a base material having grains of unexpanded perlite ore having a selected distribution of particles in the range of about 10 μm to about 170 μm.

28. A surface treating method comprising the steps of:
providing a work piece having a surface to be treated;
forming a carrier gas stream containing an unexpanded perlite ore polishing composition having grains of unexpanded perlite ore having a selected distribution of sizes having a (d₉₀) in the range of between about 60 μm and 245 μm, said grains of unexpanded perlite ore having a hardness greater than the hardness of the surface of the work piece; and
directing said carrier gas stream having said grains of unexpanded perlite ore at a selected velocity against a surface of the work piece with an incident angle to the perpendicular of said surface at a selected angle so as to cause polishing of the surface of the work piece by said grains of unexpanded perlite ore under an abrasive force of said carrier as stream resulting in continued fracturing of the grains of unexpanded perlite ore to yield a final polishing composition sufficient to polish the surface of the work piece.

29. The surface treating method of claim 28 further comprising the steps of providing a source of carrier gas and a source of a perlite ore polishing composition.

30. A device for directing an unexpanded perlite ore polishing composition under a gas stream against a surface of a work piece, said device comprising:
a nozzle assembly having nozzle having orifice defining a predetermined dimension, said nozzle assembly having a first input and a second input;
a pressurized gas source operatively connected to said first input; and
a source of unexpanded perlite ore polishing composition operatively connected to said second input, said unexpanded perlite ore polishing composition comprising a base material having grains of an unexpanded perlite ore of a selected distribution of particle sizes which result in continued fracturing of the grains as a function of an abrasive force of said pressurized gas source, said selected distribution of particle sizes having a particle size (d₉₀) less than about 245 μm, said base material being responsive to a said abrasive force being applied to the base material resulting in continued fracturing of the grains of unexpanded perlite ore to yield a final polishing composition having a sufficiently low level of abrasiveness making it suitable for use in polishing;
said nozzle being configured for directing under the pressurized gas stream, the unexpanded perlite ore polishing composition against and polishing the surface of a work piece.

31. In combination,
a polishing composition comprising
a base material having grains of unexpanded perlite ore of a selected distribution of particle sizes which undergo fracturing of the grains as a function of an abrasive force applied to the base material, said selected distribution of particle sizes including a significant volume of grains of unexpanded perlite ore having a particle size of less than about 245 μm, said base material being responsive to an abrasive force being applied thereto during polishing resulting in continued fracturing of the grains of unexpanded perlite ore to yield a final polishing composition having a sufficiently low level of abrasiveness under said abrasive force making it suitable for use in polishing
a filler material comprising grains of expanded perlite material having a density in the range of about 2 lbs. per cubic feet and about 20 lbs. per cubic feet.

32. The combination of claim 31 wherein the density of the expanded perlite material is in the range of about 7 lbs. per cubic feet and about 15 lbs. per cubic feet.

33. A dental prophalaxis paste comprising
a composition
a base material having grains of unexpanded perlite ore of a selected distribution of particle sizes which undergo fracturing of the grains as a function of an abrasive force applied to the base material, said selected distribution of particle sizes including a significant volume of grains of unexpanded perlite ore having a particle size of less than about 245 μm, said base material being responsive to an abrasive force being applied thereto during polishing resulting in continued fracturing of the grains of unexpanded perlite ore to yield a final polishing composition having a sufficiently low level of abrasiveness under said abrasive force making it suitable for use in polishing; and
a paste component.

34. The dental prophalaxis paste claim 33 wherein said final polishing composition, subsequent to the application of an abrasive force, contains a particle size distribution with a greater number of smaller grains sizes than the selected distribution of particle sizes of smaller grains sizes in said base material.

35. The dental prophalaxis paste of claim 33 wherein said base perlite material has a (d₉₀) particle size in the range of about 50 μm to about 245 μm.

36. The dental prophalaxis paste of claim 33 wherein said base perlite material has a (d₉₀) particle size of less than 245 μm and said final polishing composition has a (d₉₀) particle size in the range of about 20 μm to about 100 μm.

37. The dental prophalaxis paste claim 33 wherein said base perlite material has a (d₉₀) particle size in the range of about 50 μm to about 245 μm and the final polishing composition has a distribution of particle sizes in the range of about 20 μm to about 50 μm.

38. A strip material for polishing teeth comprising
a strip member configured for polishing teeth; and
a base material incorporated into said strip material wherein the base material includes grains of unexpanded perlite ore of a selected distribution of particle sizes which undergo fracturing of the grains as a function of an abrasive force applied to the base material, said selected distribution of particle sizes including a significant volume of grains of unexpanded perlite ore having a particle size of less than about 245 μm, said base material being responsive to an abrasive force being applied thereto during polishing resulting in continued fracturing of the grains of unexpanded perlite ore to yield a final polishing composition having a sufficiently low level of abrasiveness under said abrasive force making it suitable for use in polishing.

39. The strip material of claim 38 wherein said strip member comprises a material configured for use as a dental floss.

40. The strip material of claim 38 wherein said strip member comprises a material configured for use as a dental tape.
